(19) United States
(12) Patent Application Publication
(10) Pub. No.: US 2015/0059325 A1
(43) Pub. Date: Mar. 5, 2015

(54) Hybrid Apparatus and Method for Hydraulic Systems

(71) Applicant: Caterpillar Inc., Peoria, IL (US)

(72) Inventors: Michael Knussman, East Peoria, IL (US); Jeffrey Kuehn, Germantown Hills, IL (US); Jeremy Peterson, Washington, IL (US); Viral S. Mehta, Peoria, IL (US)

(73) Assignee: Caterpillar Inc., Peoria, IL (US)

(21) Appl. No.: 14/016,566

(22) Filed: Sep. 3, 2013

(51) Int. Cl. F15B 11/024; E02F 9/22; F15B 21/14

(52) U.S. Cl. CPC F15B 11/024; F15B 21/14; E02F 9/2289
USPC 60/327; 60/419

(57) ABSTRACT

A hydraulic system is disclosed. The hydraulic system includes a first actuator fluidly coupled to a first rotating group in a first closed-loop circuit, a flow control module fluidly coupled to the first closed-loop circuit via a first conduit, a second actuator fluidly coupled to the flow control module via a second conduit, a second rotating group in selective fluid communication with the first conduit and the second conduit via the flow control module, and a controller operatively coupled to the flow control module. The controller is configured to operate the flow control module in a first mode and a second mode. The first mode effects fluid communication between the second rotating group and the first closed-loop circuit via the first conduit, and blocks fluid communication between the second rotating group and the second actuator via the second conduit.

### TECHNICAL FIELD

This patent disclosure relates generally to hydraulic systems and, more particularly, to a hybrid closed-loop system for selectively driving two or more hydraulic actuators.

### BACKGROUND

Hydraulic systems are known for converting fluid energy, tier example, fluid pressure, into mechanical power. Fluid power may be transferred from one or more hydraulic pumps through fluid conduits to one or more hydraulic actuators. Hydraulic actuators may include hydraulic motors that convert fluid power into shaft rotational power, hydraulic cylinders that convert fluid power into translational motion, or other hydraulic actuators known in the art.

In an open-loop hydraulic system, fluid discharged from an actuator is directed to a low-pressure reservoir, from which the pump draws fluid. In a closed-loop hydraulic system, a pump is coupled to a hydraulic motor through a motor supply conduit and a pump return conduit, such that all of the hydraulic fluid is not returned to a low-pressure reservoir upon each pass through the closed-loop. Instead, fluid discharged from an actuator in a closed-loop system is directed back to the pump for immediate recirculation.

A hydraulic actuator may receive fluid power from more than one pump. For example, even in so-called closed-loop systems, fluid may be diverted out of the closed-loop to limit pressure, or be deliberately flushed from the closed-loop circuit to a reservoir, to control a hydraulic fluid property such as temperature, viscosity, cleanliness, or the like. Thus, an actuator in a closed-loop system may receive fluid power from an external boost pump in addition to the closed-loop circuit pump to compensate for fluid diverted out of the closed-loop.

Conversely, a pump may supply fluid power to more than one actuator throughout a duty cycle of a machine. For example, U.S. Pat. No. 8,191,290 (hereinafter “the '290 patent), entitled “Displacement-Controlled Hydraulic System for Multi-Function Machines,” purports to describe a hydraulic system capable of switching outputs of individual pumps between actuators to sequentially control multiple different machine functions of a multi-function machine. In turn, the '290 patent touts a machine using a number of pumps less than the number of multiple functions of the machine.

According to the '290 patent, valves enable switching of one pump between control of a swing motor and control of a blade actuator, and switching of another pump between a bucket control function and an actuator that controls an offset function of an articulated arm. However, as a result, the swing function and the blade function described in the '290 patent may not be performed simultaneously, and the bucket control function and the articulated arm offset function described in the '290 patent may not be performed simultaneously, thereby posing limited operability of the multiple functions.

Accordingly, there is a need for an improved hydraulic system to address the problems described above and/or problems posed by other conventional approaches.

### SUMMARY

In one aspect, the disclosure describes a hydraulic system. The hydraulic system includes a first actuator fluidly coupled to a first rotating group in a first closed-loop circuit, a flow control module fluidly coupled to the first closed-loop circuit via a first conduit, a second actuator fluidly coupled to the flow control module via a second conduit, a second rotating group in selective fluid communication with the first conduit and the second conduit via the flow control module, and a controller operatively coupled to the flow control module. The controller is configured to operate the flow control module in a first mode, such that the flow control module effects fluid communication between the second rotating group and the first closed-loop circuit via the first conduit, and blocks fluid communication between the second rotating group and the second actuator via the second conduit, and operate the flow control module in a second mode, such that the flow control module blocks fluid communication between the second rotating group and the first closed-loop circuit via the first conduit, and effects fluid communication between the second rotating group and the second actuator via the second conduit.

In another aspect, the disclosure describes a machine including a hydraulic system. The hydraulic system includes a first actuator fluidly coupled to a first rotating group in a first closed-loop circuit, a flow control module fluidly coupled to the first closed-loop circuit via a first conduit, a second actuator fluidly coupled to the flow control module via a second conduit, a second rotating group in selective fluid communication with the first conduit and the second conduit via the flow control module, and a controller operatively coupled to the flow control module. The controller is configured to operate the flow control module in a first mode, such that the flow control module effects fluid communication between the second rotating group and the first closed-loop circuit via the first conduit, and blocks fluid communication between the second rotating group and the second actuator via the second conduit, and operate the flow control module in a second mode, such that the flow control module blocks fluid communication between the second rotating group and the first closed-loop circuit via the first conduit, and effects fluid communication between the second rotating group and the second actuator via the second conduit.

In yet another aspect, the disclosure describes a method of controlling a hydraulic system. The hydraulic system includes a first actuator fluidly coupled to a first rotating group in a first closed-loop circuit, a flow control module fluidly coupled to the first closed-loop circuit via a first conduit, a second actuator fluidly coupled to the flow control module via a second conduit, and a second rotating group in selective fluid communication with the first conduit and the second conduit via the flow control module. The method includes operating the flow control module in a first mode and operating the flow control module in a second mode. Operating the flow control module in the first mode includes effecting fluid communication between the second rotating group and the first closed-loop circuit via the first conduit, and blocking fluid communication between the second rotating group and the second actuator via the second conduit. Operating the flow control module in the second mode includes blocking fluid communication between the second rotating group and the first closed-loop circuit via the first conduit, and effecting fluid communication between the second rotating group and the second actuator via the second conduit.

### BRIEF DESCRIPTION OF THE DRAWINGS

FIG. 1 illustrates an exemplary machine, according to an aspect of the disclosure.

FIG. 2 shows a schematic view of a linear hydraulic cylinder, according to an aspect of the disclosure.

FIG. 3 shows a schematic view of a hydraulic system, according to an aspect of the disclosure.

FIG. 4 shows a schematic view of a hydraulic system, according to an aspect of the disclosure.

FIG. 5 shows a schematic view of a hydraulic system, according to an aspect of the disclosure.

FIG. 6 shows a schematic view of a hydraulic system, according to an aspect of the disclosure.

### DETAILED DESCRIPTION

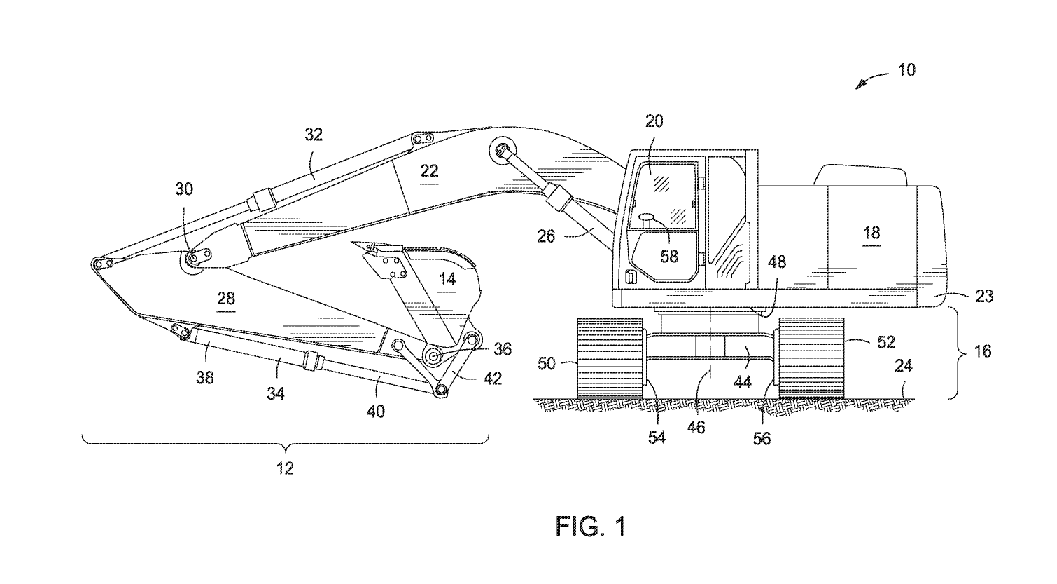

FIG. 1 illustrates an exemplary machine 10 having various systems and components that cooperate to accomplish a task. The machine 10 may embody a fixed or mobile machine that performs some type of operation associated with an industry such as mining, construction, farming, transportation, or another industry known in the art. For example, the machine 10 may be an earth moving machine such as an excavator (shown in FIG. 1), a dozer, a loader, a backhoe, a motor grader, a dump truck, or another earth moving machine. The machine 10 may include an implement system 12 configured to move a work tool 14, a drive system 16 for propelling the machine 10, a power source 18 or other prime mover that provides power to the implement system 12 and the drive system 16, and an operator station 20 that may include control interfaces for manual control of the implement system 12, the drive system 16, and/or the power source 18.

The implement system 12 may include a linkage structure coupled to hydraulic actuators, which may include linear or rotary actuators, to move the work tool 14. For example, the implement system 12 may include a boom 22 that is pivotally coupled to a body 23 of the machine 10 about a first horizontal axis (not shown), with respect to the work surface 24, and actuated by one or more double-acting, boom hydraulic cylinders 26 (only one shown in FIG. 1). The implement system 12 may also include a stick 28 that is pivotally coupled to the boom 22 about a second horizontal axis 30, with respect to the work surface 24, and actuated by a double-acting, stick hydraulic cylinder 32.

The implement system 12 may further include a double-acting, tool hydraulic cylinder 34 that is operatively coupled between the stick 28 and the work tool 14 to pivot the work tool 14 about a third horizontal axis 36. In the non-limiting aspect illustrated in FIG. 1, a head-end 38 of the tool hydraulic cylinder 34 is connected to a portion of the stick 28, and an opposing rod-end 40 of the tool hydraulic cylinder 34 is connected to the work tool 14 by way of a power link 42. The body 23 may be connected to an undercarriage 44 to swing about a vertical axis 46 by a hydraulic swing motor 48.

Numerous different work tools 14 may be attached to a single machine 10 and controlled by an operator. The work tool 14 may include any device used to perform a particular task such as, for example, a bucket (shown in FIG. 1), a fork arrangement, a blade, a shovel, a ripper, a dump bed, a broom, a snow blower, a propelling device, a cutting device, a grasping device, or any other task-performing device known in the art. Although the aspect illustrated in FIG. 1 shows the work tool 14 configured to pivot in the vertical direction relative to the body 23 and to swing in the horizontal direction about the pivot axis 46, it will be appreciated that the work tool 14 may alternatively or additionally rotate relative to the stick 28, slide, open and close, or move in any other manner known in the art.

The drive system 16 may include one or more traction devices powered to propel the machine 10. As illustrated in FIG. 1, the drive system 16 may include a left track 50 located on one side of the machine 10, and a right track 52 located on an opposing side of the machine 10. The left track 50 may be driven by a left travel motor 54, and the right track 52 may be driven by a right travel motor 56. It is contemplated that the drive system 16 could alternatively include traction devices other than tracks, such as wheels, belts, or other known traction devices. The machine 10 may be steered by generating a speed and/or rotational direction difference between the left travel motor 54 and the right travel motor 56, while straight travel may be effected by generating substantially equal output speeds and rotational directions of the left travel motor 54 and the right travel motor 56.

The power source 18 may include a combustion engine such as, for example, a reciprocating compression ignition engine, a reciprocating spark ignition engine, a combustion turbine, or another type of combustion engine known in the art. It is contemplated that the power source 18 may alternatively include a non-combustion source of power such as a fuel cell, a power storage device, or another power source known in the art. The power source 18 may produce a mechanical or electrical power output that may then be converted to hydraulic power for moving the linear or rotary actuators of the implement system 12.

The operator station 20 may include devices that receive input from an operator indicative of desired maneuvering. Specifically, the operator station 20 may include one or more operator interface devices 58, for example a joystick (shown in FIG. 1), a steering wheel, or a pedal, that are located near an operator seat (not shown). Operator interface devices may initiate movement of the machine 10, for example travel and/or tool movement, by producing displacement signals that are indicative of desired machine 10 maneuvering. As an operator moves interface device 58, the operator may affect a corresponding machine 10 movement in a desired direction, with a desired speed, and/or with a desired force.

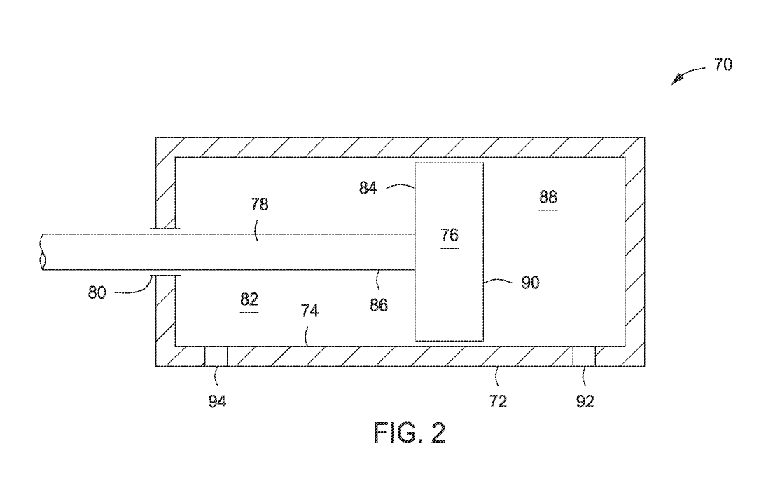

FIG. 2 shows a schematic view of a linear hydraulic cylinder 70, according to an aspect of the disclosure. The linear hydraulic cylinder 70 may include a tube 72 defining a cylinder bore 74 therein, and a piston assembly 76 disposed within the cylinder bore 74. A rod 78 is coupled to the piston assembly 76 and extends through the tube 72 at a seal 80. A rod-end chamber 82 is defined by a first face 84 of the piston, the cylinder bore 74, and a surface 86 of the rod 78. A head-end chamber 88 is defined by a second face 90 of the piston and the cylinder bore 74.

The head-end chamber 88 and the rod-end chamber 82 of the linear hydraulic actuator 70 may be selectively supplied with pressurized fluid or drained of fluid via the head-end port 92 and the rod-end port 94, respectively, to cause piston assembly 76 to translate within tube 72, thereby changing the effective length of the actuator to move work tool 14, for example. A flow rate of fluid into and out of the head-end chamber 88 and the rod-end chamber 82 may relate to a translational velocity of the actuator, while a pressure differential between the head-end chamber 88 and the rod-end chamber 82 may relate to a force imparted by the actuator on work tool 14. It will be appreciated that any of the boom hydraulic cylinders 26, the stick hydraulic cylinder 32, or the tool hydraulic cylinder 34, shown in FIG. 1, may embody structural features of the linear hydraulic actuator 70 illustrated in FIG. 2.

A hydraulic area of the second face 90 of the piston may be greater than a hydraulic area of the first face 84 of the piston, at least because the rod 78 blocks fluid from acting on a portion of the first face 84. According to an aspect of the disclosure, a hydraulic area of the second face 90 is substantially equal to a hydraulic area of the first face 84 plus a radial cross sectional area of the rod 78. Thus, a change in head-end chamber 88 fluid volume for a given translation of the piston assembly 76 may be substantially equal to the change in rod-end chamber 82 fluid volume plus the corresponding volume of the rod 78 displaced by the translation of the piston 76.

Accordingly, it will be appreciated that a volume of fluid displaced out of the rod-end port 94 to increase an effective length of the linear hydraulic actuator 70 may be smaller than a corresponding volume of fluid added to the head-end port 92 to maintain the head-end chamber 88 full of fluid. Conversely, it will be appreciated that a volume of fluid displaced out of the head-end port 92 to decrease an effective length of the linear hydraulic actuator 70 may be larger than a corresponding volume of fluid delivered through the rod-end port 94. This difference between rod-end chamber 82 fluid displacement and head-end chamber 88 fluid displacement may be referred to herein as the “head-end disparity” of a hydraulic cylinder.

A rotary actuator may include first and second chambers located to either side of a fluid work-extracting mechanism such as an impeller, plunger, or series of pistons. When the first chamber is filled with pressurized fluid and the second chamber is simultaneously drained of fluid, the fluid work-extracting mechanism may be urged to rotate in a first direction by a pressure differential across the pumping mechanism. Conversely, when the first chamber is drained of fluid and the second chamber is simultaneously filled with pressurized fluid, the fluid work-extracting mechanism may be urged to rotate in an opposite direction by the pressure differential. The flow rate of fluid into and out of the first and second chambers may determine a rotational velocity of the actuator, while a magnitude of the pressure differential across the pumping mechanism may determine an output torque. It will be appreciated that any of the hydraulic swing motor 48, the left travel motor 54, or the right travel motor 56, illustrated in FIG. 1, may embody the rotary actuator structure described above. Further, it will be appreciated that rotary actuators may have a fixed displacement or a variable displacement, as desired.

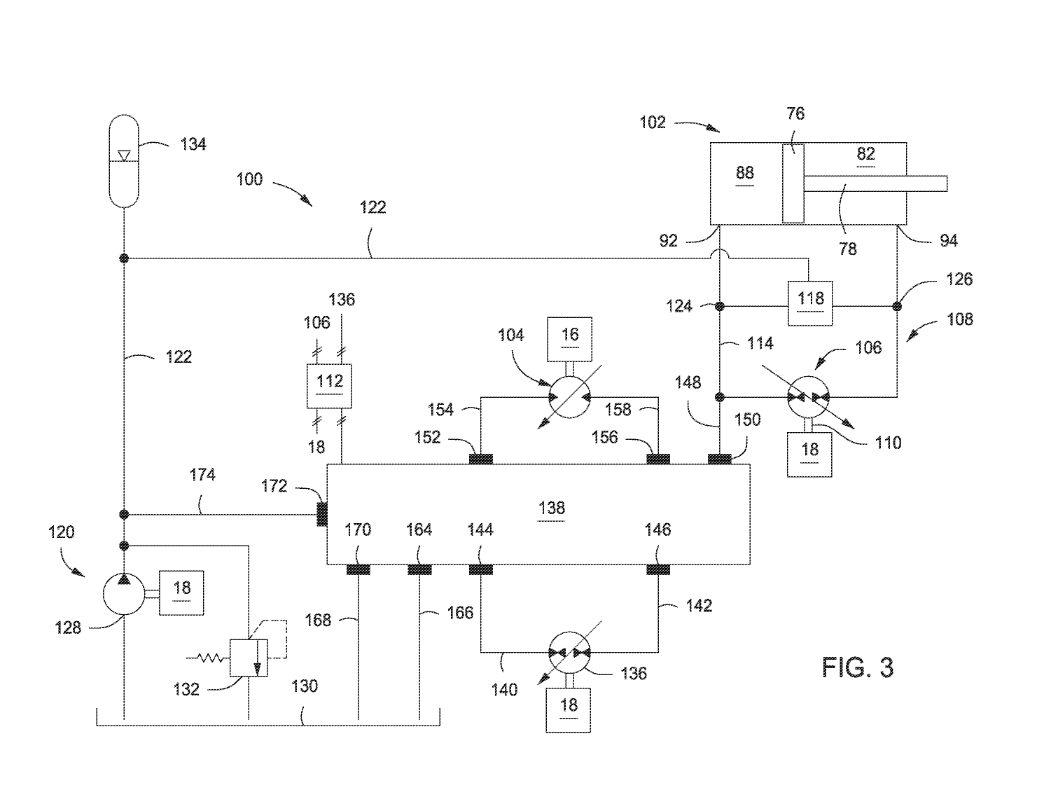

FIG. 3 shows a hydraulic system 100, according to an aspect of the disclosure. The hydraulic system 100 includes a first actuator 102 and a second actuator 104. The first actuator 102 may embody the structure of the linear hydraulic actuator 70 illustrated in FIG. 2. Thus, the first actuator 102 may have a head-end chamber 88, a rod-end chamber 82, a head-end port 92, and a rod-end port 94. It will be appreciated that the first actuator 102 may be a boom hydraulic cylinder 26, a stick hydraulic cylinder 32, or a tool hydraulic cylinder 34 of the machine 10, as shown in FIG. 1, or serve any other hydraulic cylinder function known in the art.

The second actuator 104 may be a rotary actuator, as described previously. Thus, the second actuator 104 may be the hydraulic swing motor 48, the left travel motor 54, or the right travel motor 56 of the machine 10, as illustrated in FIG. 1, or serve any other hydraulic motor function known in the art. According to an aspect of the disclosure, the second actuator 104 is the left travel motor 54 of the machine 10. According to another aspect of the disclosure, the first actuator 102 is a boom hydraulic cylinder 26 of the machine 10.

The first actuator 102 is fluidly coupled to a first rotating group 106 in a first closed-loop circuit 108. The first rotating group 106 may act as a pump to convert input shaft power into fluid power within the first closed-loop circuit 108, or the first rotating group 106 may act as a motor to convert fluid power within the first closed-loop circuit 108 into output shaft power. Further, the first rotating group 106 may be coupled to the power source 18 of the machine 10 directly or indirectly through a shaft 110. Indirect coupling between the shaft 110 of the first rotating group 106 and the power source 18 may include a torque converter, a gear box, an electrical circuit, or other coupling method known in the art. Thus, the first rotating group 106 may either accept shaft power from the power source 18 of the machine 10, or may deliver shaft power to the power source 18 of the machine 10 through the shaft 110.

The first rotating group 106 may have variable displacement, which is controlled via controller 112 to draw fluid from its associated actuators and discharge the fluid at a specified elevated pressure back to the actuators in two different directions (i.e., the first rotating group 106 may be an over-center pump). The first rotating group 106 may include a stroke-adjusting mechanism, for example a swashplate, a position of which is hydro-mechanically adjusted based on, among other things, a desired speed of the actuators, to thereby vary an output (e.g., a discharge rate) of the first rotating group 106. It is contemplated that first rotating group 106 may be coupled to the power source 18 in tandem (e.g., via the same shaft) or in parallel (e.g., via a gear train) with other pumps (not shown) of the machine 10, as desired.

Further, the displacement of the first rotating group 106 may be adjusted from a zero displacement position at which substantially no fluid is discharged from first rotating group 106, to a maximum displacement position in a first direction at which fluid is discharged from first rotating group 106 at a maximum rate into the conduit 114 of the first closed-loop circuit 108. Likewise, the displacement of first rotating group 106 may be adjusted from the zero displacement position to a maximum displacement position in a second direction at which fluid is discharged from first rotating group 106 at a maximum rate into the conduit 116 of the first closed-loop circuit 108.

The first rotating group 106 may also operate selectively as a motor. More specifically, when an associated actuator is operating in an overrunning condition (i.e., a condition where the actuator fluid discharge pressure is greater than the actuator fluid inlet pressure), the fluid discharged from the actuator may have a pressure elevated above an output pressure of the first rotating group 106. In this situation, the elevated pressure of the actuator fluid directed back through the first rotating group 106 may act to drive the first rotating group 106 to rotate without assistance from the power source 18. Under some circumstances, the first rotating group 106 may even be capable of imparting energy to the power source 18, thereby improving an efficiency and/or capacity of the power source 18.

It will be appreciated by those of skill in the art that the respective rates of fluid flow into and out of the first actuator 102 (if embodied as a linear actuator) during extension and retraction may not be equal. As discussed previously with respect to FIG. 2, more fluid may be forced out of the head-end chamber 88 than may be received by the rod-end chamber 82 during retraction of the first actuator 102, and conversely, during extension of the first actuator 102, more hydraulic fluid may be consumed by the head-end chamber 88 than is discharged from the rod-end chamber 82. Thus, in order to accommodate the excess fluid discharged during retraction, and the additional fluid required during extension, the first closed-loop circuit 108 may include a makeup circuit 118 in fluid communication with a boost system 120 through boost conduit 122, and in fluid communication with the first closed-loop circuit 108 at nodes 124 and 126, for example.

The makeup circuit 118 may be configured to deliver hydraulic fluid from the boost conduit 122 into the first closed-loop circuit 108 when a pressure in the first closed-loop circuit is less than a first threshold pressure, and may be configured to discharge fluid from the first closed-loop circuit 108 into the boost conduit 122 when a pressure in the first closed-loop circuit 108 is greater than a second threshold pressure. It will be appreciated that the first threshold pressure, the second threshold pressure, or both may be related to a pressure in the boost conduit 122.

The boost system 120 includes a boost pump 128, which draws fluid from a hydraulic reservoir 130 and discharges the fluid into the boost conduit 122. The boost pump 128 may be driven directly or indirectly by the power source 18 of the machine 10, or another power source. The boost system may further include a relief valve 132 that drains fluid from the boost conduit 122 when a pressure in the boost conduit 122 exceeds a third threshold value. The relief valve 132 may discharge fluid drained from the boost conduit 122 to the hydraulic reservoir 130 or any other point in the hydraulic system 100 with sufficiently low pressure.

The boost system 120 may also include an accumulator 134 in fluid communication with the boost conduit 122. The accumulator 134 may store hydraulic energy as a displacement of a resilient member included therein. The resilient member of the accumulator 134 may be a volume of a gas, a resilient bladder, a coil spring, a leaf spring, combinations thereof, or other resilient member known to persons having skill in the art. It will be appreciated that a fluid capacitance of the accumulator 134 may act to filter pressure oscillations in the boost conduit 122, and a fluid resistance imposed on hydraulic fluid entering and exiting the accumulator 134 may act to damp pressure oscillations in the boost conduit 122.

Thus, the boost pump 128, the accumulator 134, or combinations thereof may deliver fluid into the first closed-loop circuit 108 via the makeup circuit 118. Alternatively, the relief valve 132, the accumulator 134, or combinations thereof may receive fluid discharged from the first closed-loop circuit 108 via the makeup circuit 118.

The hydraulic system 100 includes a second rotating group 136 that is fluidly coupled to a flow control module 138 via conduits 140, 142 extending to ports 144 and 146, respectively. Further, the second rotating group 136 is operatively coupled to a source of shaft power, such as, for example, the power source 18 of the machine 10, or another power source. Similar to the first rotating group 106, the second rotating group 136 may function as a pump or a motor, may have a variable displacement controlled by the controller 112, and may embody the operational characteristics of an over-center pump, as discussed previously.

As a pump, the second rotating group 136 may impart fluid energy across port 144 and port 146, and may delivery fluid power to the flow control module 138 in either of two flow directions, namely toward port 144 or toward port 146. As a motor, the second rotating group 136 may convert fluid energy across port 144 and port 146 into torque, and transmit shaft power out of the second rotating group 136 in either a first direction or a second direction.

The flow control module 138 may selectively effect various states of fluid communication between the components of the hydraulic system 100. In a first mode of operation, the flow control module 138 effects fluid communication between the second rotating group 136 and the first closed-loop circuit 108 via a conduit 148 connected to the port 150 of the flow control module 138. Thus, when the flow control module 138 is operated in the first mode, the second rotating group 136 may act as a pump to deliver fluid power to the first closed-loop circuit 108 via conduit 142, or the second rotating group 136 may act as a motor to convert fluid power from the first closed-loop circuit 108 into shaft power.

The first mode of the flow control module 138 may block fluid communication between the second rotating group 136 and the second actuator 104, which is fluidly coupled to the flow control module 138 at port 152 via conduit 154, and at port 156 via conduit 158. According to an aspect of the disclosure, the first mode of operation of the flow control module 138 blocks all fluid communication between either port 152 or port 156 and any other port of the flow control module 138.

Alternatively, a second operating mode of the flow control module 138 may effect fluid communication between the second rotating group 136 and the second actuator 104, and may block fluid communication between the second rotating group 136 and the first closed-loop circuit 108 via the flow control module 138. Thus, in the second operating mode, the second rotating group 136 may deliver fluid power to the second actuator 104, or convert fluid power received from the second actuator 104 into shaft power.

In the second operating mode, the second rotating group 136 may operate in either an open-loop circuit or a closed-loop circuit. In an open-loop configuration, the flow control module 138 may effect fluid communication between port 144 and the hydraulic fluid reservoir 130 via port 164 and conduit 166, and effect fluid communication between port 146 and either port 152 or port 156, depending on the direction the second actuator 104 is to be driven. In turn, whichever of port 152 and port 156 is not coupled to port 146 is placed in fluid communication with a return conduit 168 to the hydraulic reservoir via port 170, according to the second mode.

In a closed-loop configuration of the second operating mode for the second rotating group 136, the flow control module couples port 146 to port 156, and couples port 152 to port 144. Then, the direction of motion of the second actuator 104 is determined by the direction of fluid flow through the second rotating group 136. In its closed-loop configuration, one or both of port 144 and port 146 may be in fluid communication with the boost system 120 via port 172 and conduit 174 to at least provide makeup flow to the closed-loop including the second rotating group 136.

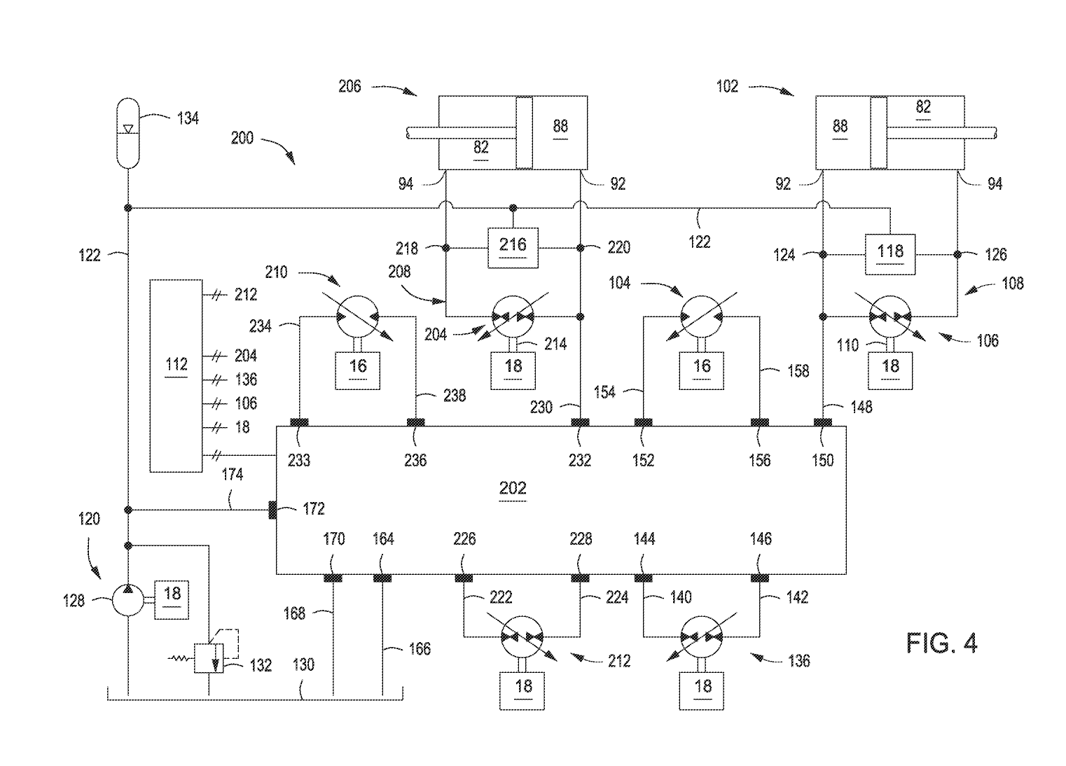

FIG. 4 shows a hydraulic system 200, according to an aspect of the disclosure. Similar to the hydraulic system 100 shown in FIG. 3, the hydraulic system 200 includes a first rotating group 106 fluidly coupled to a first actuator 102 via a first closed-loop circuit 108, a second actuator 104, a second rotating group 136, and a boost system 120. The hydraulic system 200 further includes a flow control module 202 fluidly coupled to the first closed-loop circuit 108 via the conduit 148, fluidly coupled to the second actuator 104 via the conduits 154 and 158, and fluidly coupled to the second rotating group 136 via the conduits 140 and 142. The flow control module 202 may operate in first mode or a second mode which effect the states of fluid communication between ports 144, 146, 150, 152, 156, 164, 170, and 172 as described above with respect to the hydraulic system 100, shown in FIG. 3. Further, the controller 112 may cause the flow control module 202 to switch between operational modes according to a control signal transmitted from the controller 112 to the flow control module 202.

In addition, the hydraulic system 200 further includes a third rotating group 204 fluidly coupled to a third actuator 206 via a second closed-loop circuit 208, a fourth actuator 210, and a fourth rotating group 212. The third actuator 206 may embody structural features of the linear hydraulic actuator 70 illustrated in FIG. 2. Thus, the third actuator 206 may have a head-end chamber 88, a rod-end chamber 82, a head-end port 92, and a rod-end port 94. It will be cylinder 32, or a tool hydraulic cylinder 34 of the machine 10, as shown in FIG. 1, or serve any other hydraulic cylinder function known in the art.

The fourth actuator 210 may be a rotary actuator, as described previously. Thus, the fourth actuator 210 may be the hydraulic swing motor 48, the left travel motor 54, or the right travel motor 56 of the machine 10, as illustrated in FIG. 1, or serve any other hydraulic motor function known in the art. According to an aspect of the disclosure, the fourth actuator 210 is right travel motor 56 of the machine 10 (see FIG. 1). According to another aspect of the disclosure, the third actuator 206 is the stick hydraulic cylinder 32 of the machine 10 (see FIG. 1).

The third rotating group 204 may act as a pump to convert input shaft power into fluid power within the second closed-loop circuit 208, or the third rotating group 204 may act as a motor to convert fluid power within the second closed-loop circuit 208 into output shaft power. Further, the third rotating group 204 may be coupled to the power source 18 of the machine 10 directly or indirectly through a shaft 214. Indirect coupling between the shaft 214 of the third rotating group 204 and the power source 18 may include a torque converter, a gear box, an electrical circuit, or other coupling method known in the art. Thus, the third rotating group 204 may either accept shaft power from the power source 18 of the machine 10, or may deliver shaft power to the power source 18 of the machine 10 through the shaft 214. Similar to the first rotating group 106, the third rotating group 204 may have a variable displacement and may have operational attributes of an over-center pump.

The second closed-loop circuit 208 may include a makeup circuit 216 having operation similar to or different from the makeup circuit 118. The makeup circuit 216 may be in fluid communication with the boost system 120 through the boost conduit 122, and may be in fluid communication with the second closed-loop circuit 208 at nodes 218 and 220, for example.

The makeup circuit 216 may be configured to deliver hydraulic fluid from the boost conduit 122 into the second closed-loop circuit 208 when a pressure in the second closed-loop circuit 208 is less than a fourth threshold pressure, and may be configured to discharge fluid from the second closed-loop circuit 208 into the boost conduit 122 when a pressure in the second closed-loop circuit 208 is greater than a fifth threshold pressure. It will be appreciated that the fourth threshold pressure, the fifth threshold pressure, or both may be relate to a pressure in the boost conduit 122.

The boost pump 128, the accumulator 134, or combinations thereof may deliver fluid into the second closed-loop circuit 208 via the makeup circuit 216. Alternatively, the relief valve 132, the accumulator 134, or combinations thereof may receive fluid discharged from the second closed-loop circuit 208 via the makeup circuit 216.

The fourth rotating group 212 is fluidly coupled to the flow control module 202 via conduits 222, 224 extending to port 226 and port 228, respectively. Further, the fourth rotating group 212 is operatively coupled directly or indirectly to a source of shaft power, such as, for example, the power source 18 of the machine 10, or another power source. Similar to the first rotating group 106, the fourth rotating group 212 may function as a pump or a motor, may have a variable displacement, and may embody operational characteristics of an over-center pump, as discussed previously.

As a pump, the fourth rotating group 212 may impart fluid energy across port 226 and port 228, and may delivery fluid power to the flow control module 202 in either of two flow directions, namely toward port 226 or toward port 228. As a motor, the fourth rotating group 212 may convert fluid potential energy across port 226 and port 228 into torque, and may transmit shaft power out of the fourth rotating group 212 in either a first direction or a second direction.

Similar to the flow control module 138 of the hydraulic system 100 (see FIG. 3), the flow control module 202 may selectively effect various states of fluid communication between the components of the hydraulic system 200. In the first mode of operation, the flow control module 202 effects fluid communication between the fourth rotating group 212 and the second closed-loop circuit 208 via the conduit 230 connected to the port 232 of the flow control module 202. Thus, when the flow control module 202 is operated in the first mode, the fourth rotating group 212 may act as a pump to deliver fluid power to the second closed-loop circuit 208 via conduit 230, or the fourth rotating group 212 may act as a motor to convert fluid power from the second closed-loop circuit 208 into shaft power.

The first mode of the flow control module 202 may block fluid communication between the fourth rotating group 212 and the fourth actuator 210, which is fluidly coupled to the flow control module 202 at port 232 via conduit 234, and at port 236 via conduit 238. According to an aspect of the disclosure, the first mode of operation of the flow control module 202 blocks all fluid communication between either port 232 or port 236 and any other port of the flow control module 202.

Alternatively, a second operating mode of the flow control module 202 may effect fluid communication between the fourth rotating group 212 and the fourth actuator 210, and may block fluid communication between the fourth rotating group 212 and the second closed-loop circuit 208 via the flow control module 202. Thus, in the second operating mode, the fourth rotating group 212 may deliver fluid power to the fourth actuator 210, or convert fluid power received from the fourth actuator 210 into shaft power.

In the second operating mode, the fourth rotating group 212 may operate in either an open-loop circuit or a closed-loop circuit. In an open-loop configuration, the flow control module 202 may effect fluid communication between port 226 and the hydraulic fluid reservoir 130 via port 164 and conduit 166, and effect fluid communication between port 228 and either port 233 or port 236, depending on the direction the fourth actuator 210 is to be driven. In turn, whichever of port 233 and port 236 is not coupled to port 228 is placed in fluid communication with a return conduit 168 to the hydraulic reservoir via port 170, according to the second mode.

In a closed-loop configuration of the second operating mode for the fourth rotating group 212, the flow control module 202 couples port 228 to port 236, and couples port 226 to port 233. Then, the direction of motion of the fourth actuator 210 is determined by the direction of fluid flow through the fourth rotating group 212. In its closed-loop configuration, one or both of port 226 and port 228 may be in fluid communication with the boost system 120 via port 172 and conduit 174 to at least provide makeup flow to the closed-loop including the fourth rotating group 212.

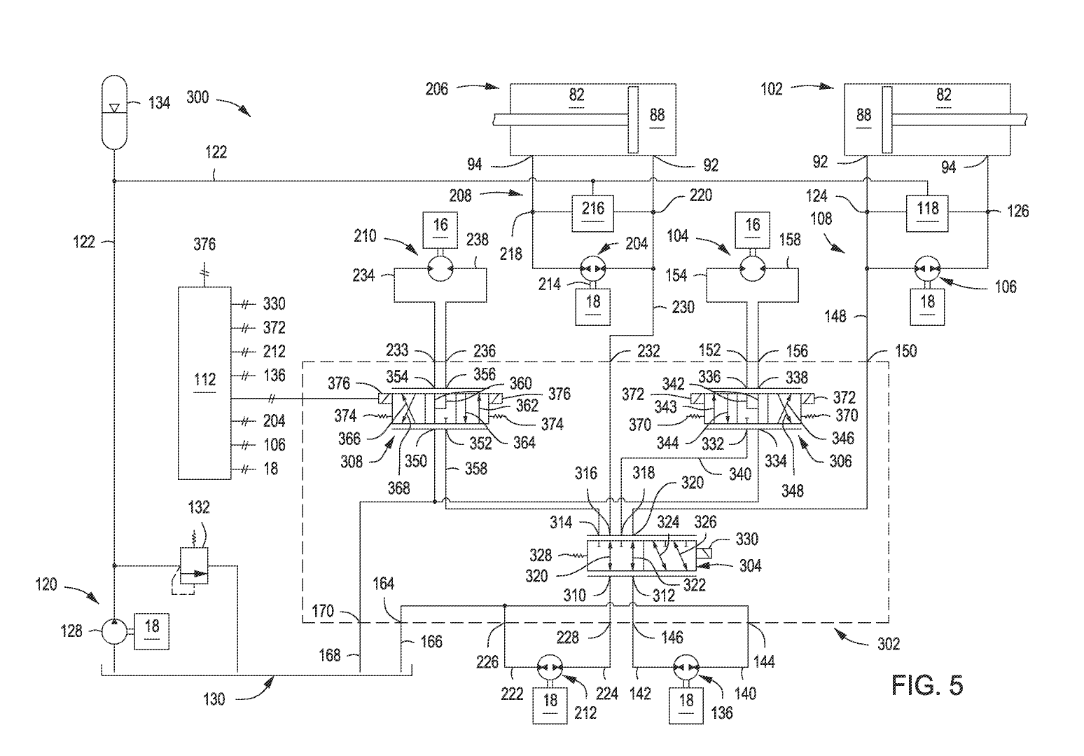

FIG. 5 shows a hydraulic system 300 according to an aspect of the disclosure. Similar to hydraulic system 200 in FIG. 4, hydraulic system 300 has a first rotating group 106, a first actuator 102, a second rotating group 136, a second actuator 104, a third rotating group 204, a third actuator 206, a fourth rotating group 212, a fourth actuator 210, and a boost system 120. The hydraulic system 300 also includes a flow control module 302 having a travel divert valve 304, a first travel direction valve 306, and a second travel direction valve 308.

The travel divert valve 304 may have six ports 310, 312, 314, 316, 318, and 320. The port 310 is fluidly coupled to the fourth rotating group 212 via conduit 224, and the port 312 is fluidly coupled to the second rotating group 136 via conduit 142. When the travel divert valve 304 is configured in a first position, the port 310 is fluidly coupled to the port 316 via valve passage 320, and the port 312 is fluidly coupled to the port 320 via valve passage 322. When the travel divert valve 304 is configured in a second position, the port 310 is fluidly coupled to the port 314 via valve passage 324, and the port 312 is fluidly coupled to the port 318 via valve passage 326.

The port 316 of the travel divert valve 304 is fluidly coupled to the second closed-loop circuit 208 via the conduit 230, and the port 320 of the travel divert valve 304 is fluidly coupled the first closed-loop circuit 108 via the conduit 148. Thus, when the travel divert valve 304 is in its first position, the second rotating group 136 is in fluid communication with the first closed-loop circuit 108 via conduit 148, and the fourth rotating group 212 is in fluid communication with the second closed-loop circuit 208 via conduit 230.

The travel divert valve 304 may include a resilient member 328 that biases the travel divert valve 304 toward its first position. The travel divert valve 304 may further include an actuator 330 that may act to urge the travel divert valve 304 toward its second position. The actuator 330 may be operatively coupled to the controller 112 such that a control signal from the controller 112 to the travel divert valve 304 may position the travel divert valve 304 proportionally between its first position and its second position. Alternatively, the actuator 330 may toggle the travel divert valve 304 between its first position and its second position in response to a control signal from the controller 112. The actuator 330 may be a hydraulic actuator, a pneumatic actuator, a solenoid actuator, or any other actuator known to those having skill in the art.

According to an aspect of the disclosure, the first position of the travel divert valve 304 corresponds to a first operational mode of the flow control module 302. According to another aspect of the disclosure, the second position of the travel divert valve 304 corresponds a second operational mode of the flow control module 302.

The first travel direction valve 306 has four ports 332, 334, 336, and 338. The port 332 of the first travel direction valve 306 is fluidly coupled to the port 318 of the travel divert valve 304 via conduit 340, and the port 334 of the first travel direction valve 306 is fluidly coupled to the reservoir 130 via conduit 168. The ports 336 and 338 of the first travel direction valve 306 are fluidly coupled to the second actuator 104 via the conduits 154 and 158, respectively.

When the first travel direction valve 306 is in a first position, the port 334 is in fluid communication with both of the ports 336 and 338 via a valve passage 342, and the port 332 is blocked from fluid communication with another port of the first travel direction valve 306 through the first travel direction valve 306. Thus, when the first travel direction valve 306 is in the first position a fluid energy potential across the second actuator 104 is substantially zero. Therefore, the second actuator 104 may not move when the first travel direction valve 306 is configured in the first position.

When the first travel direction valve 306 is in a second position, the port 332 is in fluid communication with the port 336 via the valve passage 343, and the port 334 is in fluid. communication with the port 338 via the valve passage 344. When the first travel direction valve 306 is in a third position, the port 332 is in fluid communication with the port 338 via the valve passage 346, and the port 334 is in fluid communication with the port 336 via valve passage 348. Therefore, it will be appreciated that when the travel divert valve 304 is configured in its second position and the first travel direction valve 306 is configured in its second position, the second actuator 104 may be operated in a first direction. Further, it will be appreciated that when the travel divert valve 304 is configured in its second position and the first travel direction valve 306 is configured in its third position, the second actuator 104 may be operated in a second direction.

The first travel direction valve 306 may include one or more resilient members 370, which bias the first travel direction valve 306 toward its first position. The first travel direction valve 306 may also include an actuator 372, which is configured to urge the first travel direction valve 306 selectively toward either its second position or its third position. The actuator 372 may be a hydraulic actuator, a pneumatic actuator, a solenoid actuator, or another actuator known to persons having skill in the art. Further, the actuator 372 may be operatively coupled to the controller 112 such that a control signal from the controller 112 to the first travel direction valve 306 may toggle the position of the first travel direction valve 306 between its first position, its second position, and its third position.

In hydraulic system 300, the second actuator 104 is operated in an open-loop mode such that the fluid energy potential across the second actuator 104, to drive motion thereof, is substantially the difference in fluid pressure between conduit 142 and a pressure of the hydraulic fluid reservoir 130, assuming negligible pressure losses between the second rotating group 136 and the second actuator 104.

The second travel direction valve 308 has four ports 350, 352, 354, and 356. The port 352 of the second travel direction valve 308 is fluidly coupled to the port 314 of the travel divert valve 304 via conduit 358, and the port 350 of the second travel direction valve 308 is fluidly coupled to the reservoir 130 via conduit 168. The ports 354 and 356 of the second travel direction valve 308 are fluidly coupled to the fourth actuator 210 via the conduits 234 and 238, respectively.

When the second travel direction valve 308 is in a first position, the port 350 is in fluid communication with both of the ports 354 and 356 via a valve passage 360, and the port 352 is blocked from fluid communication with another port of the second travel direction valve 308 through the second travel direction valve 308. Thus, when the second travel direction valve 308 is in the first position, a fluid energy potential across the fourth actuator 210 is substantially zero. Therefore, the fourth actuator 210 may not move when the second travel direction valve 308 is configured in the first position.

When the second travel direction valve 308 is in a second position, the port 352 is in fluid communication with the port 356 via the valve passage 362, and the port 350 is in fluid communication with the port 354 via the valve passage 364. When the second travel direction valve 308 is in a third position, the port 352 is in fluid communication with the port 354 via the valve passage 366, and the port 350 is in fluid communication with the port 356 via valve passage 368. Therefore, it will be appreciated that when the travel divert valve 304 is configured in its second position and the second travel direction valve 308 is configured in its second position, the fourth actuator 210 may be operated in a first direction. Further, it will be appreciated that when the travel divert valve 304 is configured in its second position and the second travel direction valve 308 is configured in its third position, the fourth actuator 210 may be operated in a second direction.

The second travel direction valve 308 may include one or more resilient members 374, which bias the second travel direction valve 308 toward its first position. The second travel direction valve 308 may also include an actuator 376, which is configured to urge the second travel direction valve 308 toward either its second position or its third position. The actuator 376 may be a hydraulic actuator, a pneumatic actuator, a solenoid actuator, or another actuator known to persons having skill in the art. Further, the actuator 376 may be operatively coupled to the controller 112 such that a control signal from the controller 112 to the second travel direction valve 308 may toggle the position of the travel divert valve 304 between its first position, its second position, and its third position.

In hydraulic system 300, the fourth actuator 210 is operated in an open-loop mode such that the fluid energy potential across the fourth actuator 210, to drive motion thereof, is substantially the difference in fluid pressure between conduit 224 and a pressure of the hydraulic fluid reservoir 130, assuming negligible pressure losses between the fourth rotating group 212 and the fourth actuator 210.

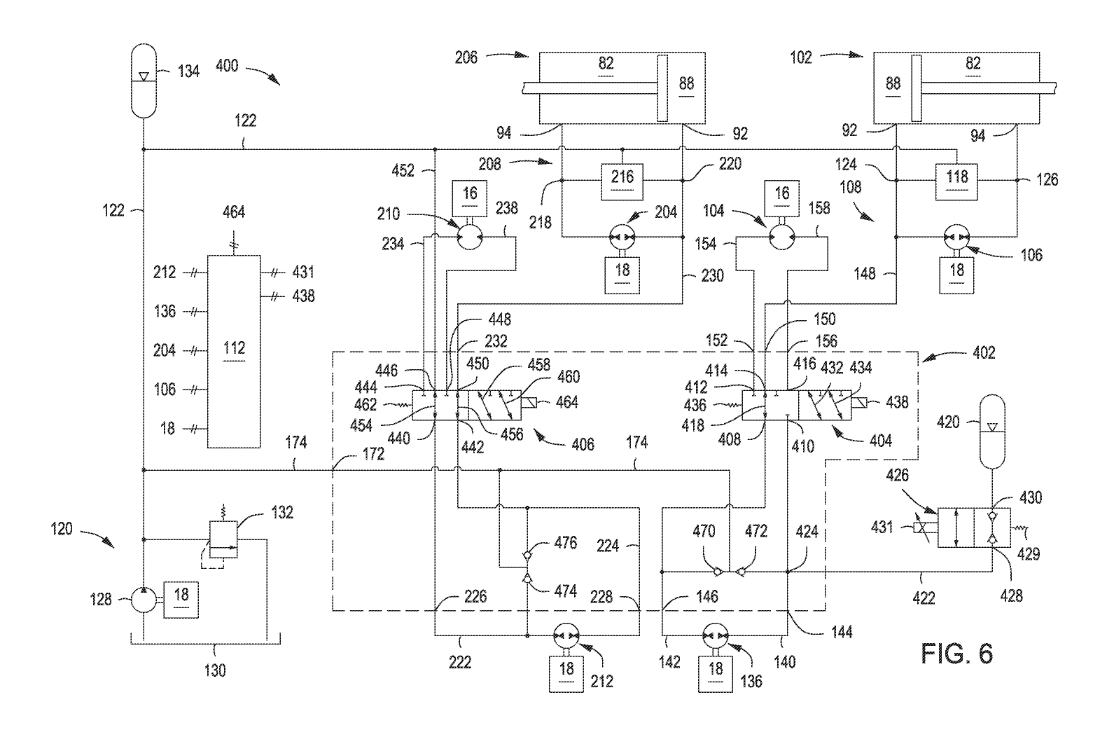

FIG. 6 shows a hydraulic system 400 according to an aspect of the disclosure. Similar to the hydraulic system 200 in FIG. 4, hydraulic system 400 has a first rotating group 106, a first actuator 102, a second rotating group 136, a second actuator 104, a third rotating group 204, a third actuator 206, a fourth rotating group 212, a fourth actuator 210, and a boost system 120. The hydraulic system 400 also includes u flow control module 402 having a first travel divert valve 404 and a second travel divert valve 406.

The first travel divert valve 404 may have five ports 408, 410, 412, 414, and 416. Port 408 and port 410 of the first travel divert valve 404 are in fluid communication with the second rotating group 136 via the conduit 142 and the conduit 140, respectively. Port 412 and port 416 of the first travel divert valve 404 are in fluid communication with the second actuator 104 via conduit 154 and conduit 158, respectively. Port 414 of the first travel divert valve is in fluid communication with the first closed-loop circuit 108 via the conduit 148.

When the first travel divert valve 404 is disposed in a first position, port 408 is fluid coupled to port 414 via valve passage 418, and ports 410, 412 and 416 are blocked from fluid communication with any other ports of the first travel divert valve 404 through the first travel divert valve 404. Thus, when the first travel divert valve 404 is disposed in the first position, the second rotating group 136 is in fluid communication with the first closed-loop circuit 108 via the first travel divert valve 404, and the second actuator 104 is blocked from fluid communication with the second rotating group 136 through the first travel divert valve 404.

When the first travel divert valve 404 is disposed in a second position, the port 408 is in fluid communication with the port 412 via the valve passage 432, the port 410 is in fluid communication with the port 416 via the valve passage 434, and the port 414 is blocked from fluid communication with any other ports of the first travel divert valve 404 via the first travel divert valve. Thus, when the first travel divert valve 404 is disposed in the second position, the second rotating group 136 is fluidly coupled with the second actuator 104 in a closed-loop circuit via the first travel divert valve 404. The hydraulic system 400 may include makeup check valves 470 and 472 to provide makeup flow from the boost system 120 to the closed-loop circuit established by the second position of the first travel divert valve 404.

The first travel divert valve 404 may include a resilient member 436 that biases the first travel divert valve toward its first position. Further, the first travel divert valve 404 may include an actuator 438 that urges the first travel divert valve 404 toward its second position. The actuator 438 may be a hydraulic actuator, a pneumatic actuator, a solenoid actuator, or any other actuator known to persons having skill in the art. The actuator 438 may be operatively coupled to the controller 112, such that the controller 112 may vary the position of the first travel divert valve 404 via a control signal transmitted from the controller 112 to the first travel divert valve 404.

According to an aspect of the disclosure, the first position of the first travel divert valve 404 corresponds to a first operational mode of the flow control module 402. According to another aspect of the disclosure, the second position of the first travel divert valve 404 corresponds to a second operational mode of the flow control module 402.

The hydraulic system 400 may include an accumulator 420 that is fluidly coupled to the second rotating group 136 via conduit 422 extending from a node 424 on conduit 144. The accumulator 420 may store hydraulic energy as a displacement of a resilient member included therein. The resilient member of the accumulator 420 may be a volume of a gas, a resilient bladder, a coil spring, a leaf spring, combinations thereof, or other resilient member known to persons having skill in the art. It will be appreciated that a fluid capacitance of the accumulator 420 may act to filter pressure oscillations in the conduit 140, and a fluid resistance imposed on hydraulic fluid entering and exiting the accumulator 420 may act to damp pressure oscillations in the conduit 140.

An accumulator valve 426 may be disposed in the conduit 422 between the node 424 and the accumulator 420, and be fluidly coupled thereto via port 428 and port 430, respectively. When the accumulator valve is disposed in a first position, the port 428 and the port 430 are blocked from fluid communication with one another. When the accumulator valve is disposed in a second position, the port 428 may be in fluid communication with the port 430. Thus, when the accumulator valve is disposed in the second position, the second rotating group 136 may be in fluid communication with the accumulator 420 via the accumulator valve 426.

The accumulator valve 426 may include a resilient member 429 that biases a position of the accumulator valve 426 toward its first position. The accumulator valve 426 may include an actuator 431 that urges the accumulator valve 426 toward its second position. The actuator 431 may be a hydraulic actuator, a pneumatic actuator, a solenoid actuator, or any other actuator known to persons of skill in the art. The actuator 431 may be operatively coupled to the controller 112, such that the controller 112 may vary a position of the accumulator valve 426. It will be appreciated that the controller 112 may cause the accumulator valve 426 to toggle between its first position and its second position, or alternatively, a position of the accumulator valve 426 may vary proportionally to a signal from the controller 112. According to an aspect of the disclosure, the second position of the accumulator valve corresponds to a first operational mode of the flow control module 402.

The second travel divert valve 406 may have six ports 440, 442, 444, 446, 448, and 450. The port 440 and the port 442 of the second travel divert valve 406 are in fluid communication with the fourth rotating group 212 via the conduit 222 and the conduit 224, respectively. Port 444 and port 448 of the second travel divert valve 406 are in fluid communication with the fourth actuator 210 via conduit 234 and conduit 238, respectively. The port 450 of the second travel divert valve 406 is in fluid communication with the second closed-loop circuit 208 via the conduit 230, and the port 446 of the second travel divert valve 406 may be in fluid communication with the boost conduit 122 via conduit 452.

When the second travel divert valve 406 is disposed in a first position, the port 440 may be in fluid communication with the port 446 via the valve passage 454, the port 442 may be in fluid communication with the port 450 via the valve passage 456, and the ports 444 and 448 may be blocked from fluid communication with any other ports of the second travel divert valve 406 via the second travel divert valve 406. Thus, when the second travel divert valve 406 is disposed in its first position, the fourth rotating group 212 may be in fluid communication with the boost conduit 122, and the second closed-loop circuit 208 via the second travel divert valve 406. Further, the first position of the second travel divert valve 406 may block fluid communication between the fourth actuator 210 and the fourth rotating group 212 via the second travel divert valve 406.

When the second travel divert valve 406 is disposed in a second position, the port 440 may be in fluid communication with the port 444 via the valve passage 458, the port 442 may be in fluid communication with the port 448 via the valve passage 460, and the ports 446 and 450 may be blocked from fluid communication with any other ports of the second travel divert valve 406 via the second travel divert valve 406. Thus, when the second travel divert valve 406 is disposed in its second position, the fourth rotating group 212 is fluidly coupled with the fourth actuator 210 in a closed-loop circuit, and the boost conduit 122 and the second closed-loop circuit 208 are blocked from fluid communication with the fourth rotating group 212 via the second travel divert valve 406. The hydraulic system 400 may include makeup check valves 474 and 476 to provide makeup flow from the boost system 120 to the closed-loop circuit established by the second position of the second travel divert valve 406.

The second travel divert valve 406 may include a resilient member 462 that biases the second travel divert valve 406 toward its first position. Further, the second travel divert valve 406 may include an actuator 464 that may urge the second travel divert valve 406 toward its second position. The actuator 464 may be a hydraulic actuator, a pneumatic actuator, a solenoid actuator, or any other actuator known to persons having skill in the art. The actuator 464 may be operatively coupled to the controller 112, such that the controller 112 may vary the position of the second travel divert valve 406 via a control signal transmitted from the controller l|2 to the second travel divert valve 406.

According to an aspect of the disclosure, the first position of the second travel divert valve 406 corresponds to a first operational mode of the flow control module 402. According to another aspect of the disclosure, the second position of the second travel divert valve 406 corresponds to a second operational mode of the flow control module 402.

### INDUSTRIAL APPLICABILITY

The present disclosure may be applicable to any machine including a hydraulic system containing two or more hydraulic actuators. Aspects of the disclosed hydraulic system and method may promote operational flexibility of multi-actuator systems while limiting the number of rotating groups required therein, and may promote operational smoothness and energy efficiency of a hydraulic system.

During operation of machine 10, shown in FIG. 1, an operator located within station 20 may command a particular motion of the work tool 14 in a desired direction and at a desired velocity by way of the interface device 58. One or more corresponding signals generated by the interface device 46 may be provided to the controller 112 indicative of the desired motion, along with machine performance information, for example sensor data such as pressure data, position data, speed data, pump or motor displacement data, and other data known in the art. In response to the signals from interface device 46 and based on the machine performance information, controller 112 may generate control signals directed to a stroke-adjusting mechanism of any of the first rotating group 106, the second rotating group 136, the third rotating group 204, the fourth rotating group 212, or combinations thereof.

For example, to drive the first hydraulic actuator 102, depicted in FIG. 3, at an increasing speed in an extending direction, the controller 112 may generate a control signal that causes the first rotating group 106 of the first closed-loop circuit 108 to increase its displacement in a first direction that results in delivery of pressurized fluid into the head-end chamber 88 via the head-end port 92 at a greater rate. When fluid from the first rotating group 106 is directed into the head-end chamber 88, return fluid from the rod-end chamber 82 of the first hydraulic actuator 102 may flow through the rod-end port 94 back toward the first rotating group 106 in a closed-loop manner.

As discussed previously, the flow rate of fluid entering the head-end port 92 may be greater than the flow rate of fluid exiting the rod-end port 94 during extension of the first hydraulic actuator 102 because of the head-end disparity. And while the makeup circuit 118 may help to provide the additional fluid to the first dosed-loop circuit 108 to fill the head-end chamber 88 while extending the first hydraulic actuator 102, the second rotating group 136 may also be used to contribute additional fluid to the first closed-loop circuit 108.

Thus, during extension of the first hydraulic actuator 102, the flow control module 138 may be operated in u first mode that effects fluid communication between the second rotating group 136 and the first closed-loop circuit 108. According to an aspect of the disclosure, the controller 112 may send a signal to the second rotating group 136 to adjust its stroke to deliver approximately the difference between the head-end fluid flow and the rod-end fluid flow to the first closed-loop circuit 108 during extension of the first hydraulic actuator 102, and the first rotating group 106 and the second rotating group 136 operate simultaneously to complete the operation. In turn, the fluid demand on the boost system 120 is reduced, allowing lower capacity components to be used therein.

Conversely, when the first hydraulic actuator 102 is contracted, the flow rate of fluid out of the head-end chamber 88 may be greater than the flow rate of fluid into the rod-end chamber 82, because of the head-end disparity. Accordingly, the difference between the head-end flow and the rod-end flow may be removed from the first closed-loop circuit 108 through the second rotating group 136, in combined operation with the first rotating group 106, by operating the flow control module 138 in the first operating mode.

Further, it will be appreciated that when the first hydraulic cylinder 102 is either extended or contracted in an overrun condition, for example, such that operation of the first hydraulic actuator imparts fluid energy to the first closed-loop circuit 108, the first rotating group 106, the second rotating group 136, or both may be operated as motors to deliver the fluid energy extracted from the first closed-loop circuit 108 to the power source 18 or the like. Alternatively, fluid energy extracted from the first closed-loop circuit 108 may be stored in the accumulator 420 by selectively opening and closing the accumulator valve 426, as shown in FIG. 6.

When the operator wishes to operate the second actuator 104, a signal from the controller 112 may configure the flow control module 138 in a second operating mode such that the second actuator 104 is driven by the second rotating group 136. The second actuator 104 may be fluidly coupled to the second rotating group 136 by operation of the travel divert valve 304 and the first travel direction valve 306, as shown in FIG. 5, or by operation of the first travel divert valve 404, as shown in FIG. 6.

When the second rotating group 136 is fluidly coupled to the second actuator 104, the second rotating group may not be available for cooperation with the first rotating group 106 to drive the first hydraulic actuator 102. However, unlike conventional approaches, the first hydraulic actuator 102 may still be operated by the first rotating group 106 in conjunction with the boost system 120 to compensate for any head-end disparity effects. Indeed, the hydraulic power demand for operating functions such as the boom hydraulic cylinder 26 and the stick hydraulic cylinder 32 may be greatly reduced when the machine 10 is moving, so much so that the boost system 120 may be sufficient to counter any head-end disparity effects from operation of the first hydraulic actuator 102 or the third hydraulic actuator 206 while the travel motors 54, 56 are operating.

It will be appreciated that the fourth rotating group 212 may be used to either compensate for head-end disparity effects while operating the third hydraulic actuator 206, or be used to operate the fourth hydraulic actuator 210 (see, e.g. FIG. 4) depending on the mode of the flow control module 202, similar to operation of the second rotating group 136 with respect to the first hydraulic actuator 102 and the second hydraulic actuator 104.

As shown in FIG. 6, when the flow control module 402 is operated in its first mode, the second rotating group 212 may be used to simultaneously exchange fluid with the second closed-loop circuit 208 and the boost system 120 via conduit 230 and conduit 452, respectively, Accordingly, the energy storage accumulator 420, shown in FIG. 6, may enable hydraulic system operation with a smaller boost accumulator 134.

Further regarding FIG. 6, it will be appreciated that fluid energy stored in the accumulator 420 may be selectively released into the hydraulic system 400 by the accumulator valve 426 to increase the hydraulic power available to the first actuator 102 and the second actuator, or delivered to the power source 18 as shaft power by using the second rotating group 136 as a motor to convert the stored fluid energy into shaft power.

According to an aspect of the disclosure, the first hydraulic actuator 102 is a boom hydraulic cylinder 26 of the machine 10, the third hydraulic actuator 206 is the stick hydraulic cylinder 32 of the machine 10, and the second hydraulic actuator 104 and the fourth hydraulic actuator 204 are the right travel motor 56 and left travel motor 54, respectively, of the machine 10 (see FIG. 1). Thus, when the flow control module is configured in its first operating mode, the first rotating group 106 and the second rotating group 136 may act together to operate the boom hydraulic cylinder 26, and the third rotating group 204 and the fourth rotating group 212 may act together to operate the stick hydraulic cylinder 32.

When the operator wishes to move the machine 10 relative to the work surface 24, the right travel motor 56 and the left travel motor 54 may be driven by the second rotating group 136 and the fourth rotating group 212, respectively, by configuring the flow control module in the second mode. And as discussed above, the boom hydraulic cylinder 26 and the stick hydraulic cylinder 32 still may be driven by the first rotating group 106 and the second rotating group 204, respectively, while the travel motors 54, 56 operate to move the machine relative to the work surface 24.

Even if not expressly stated, it is contemplated that any of the hydraulic systems 100, 200, 300, and 400 may embody structures or functions of the other hydraulic systems discussed herein, and it is contemplated that any of the flow control modules 138, 202, 302, and 402 may embody structures or functions of the other flow control modules discussed herein. Further, any of the flow control modules 138, 202, 302, and 402 may be enclosed within a single housing, or be distributed throughout their corresponding hydraulic systems in a plurality of discrete housings.

Like reference numbers refer to similar elements herein, unless otherwise specified.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A hydraulic system, comprising:
a first actuator fluidly coupled to a first rotating group in a first closed-loop circuit;
a flow control module fluidly coupled to the first closed-loop circuit via a first conduit;
a second actuator fluidly coupled to the flow control module via a second conduit;
a second rotating group in selective fluid communication with the first conduit and the second conduit via the flow control module; and
a controller operatively coupled to the flow control module, the controller being configured to
operate the flow control module in a first mode, such that the flow control module effects fluid communication between the second rotating group and the first closed-loop circuit via the first conduit, and blocks fluid communication between the second rotating group and the second actuator via the second conduit, and
operate the flow control module in a second mode, such that the flow control module blocks fluid communication between the second rotating group and the first closed-loop circuit via the first conduit, and effects fluid communication between the second rotating group and the second actuator via the second conduit.

2. The hydraulic system of claim 1, wherein the first actuator is a hydraulic cylinder having a head end separated from a rod end by a piston, and the first conduit is fluidly coupled to the head end of the first actuator via the first closed-loop circuit.

3. The hydraulic system of claim 1, further comprising:
a third actuator fluidly coupled to a third rotating group in a second closed-loop circuit, the second closed-loop circuit being fluidly coupled to the flow control module via a third conduit;
a fourth actuator fluidly coupled to the flow control module via a fourth conduit;
a fourth rotating group in selective fluid communication with the third conduit and the fourth conduit via the flow control module,
wherein the first mode of the flow control module effects fluid communication between the fourth rotating group and the second closed-loop circuit via the third conduit, and blocks fluid communication between the fourth rotating group and the fourth actuator via the fourth conduit, and
wherein the second mode of the flow control module blocks fluid communication between the fourth rotating group and the second closed-loop circuit via the third conduit, and effects fluid communication between the fourth rotating group and the fourth actuator via the fourth conduit.

4. The hydraulic system of claim 3, wherein the third actuator is a hydraulic cylinder having a head end separated from a rod end by a piston, and the third conduit is fluidly coupled to the head end of the third actuator via the second closed-loop circuit.

5. The hydraulic system of claim 1, further comprising a first accumulator in selective fluid communication with the second rotating group via a first control valve.

6. The hydraulic system of claim 1, further comprising a boost pump fluidly coupled o a boost circuit of the first closed-loop circuit via a boost conduit,
wherein the flow control module is fluidly coupled to the boost conduit,
wherein the first mode of the flow control module effects fluid communication between the second rotating group and the boost conduit via the flow control module, and
wherein the second mode of the flow control module blocks fluid communication between the second rotating group and the boost conduit via the flow control module.

7. The hydraulic system of claim 1, wherein the second rotating group is fluidly coupled to a hydraulic fluid reservoir, and the second actuator is fluidly coupled to the hydraulic fluid reservoir, such that the second mode of the flow control module effects open-loop operation of the second actuator.

8. The hydraulic system of claim 1, wherein the second actuator is fluidly coupled to the flow control module via a third conduit, and the second rotating group is in selective fluid communication with the third conduit via the flow control module, such that the second mode of the flow control module effects closed-loop operation of the second actuator.

9. The hydraulic system of claim 1, wherein the first rotating group is operatively coupled to a prime mover via a first shaft, and the second rotating group is operatively coupled to the prime mover via a second shaft.

10. A machine, comprising:
a first actuator fluidly coupled to a first rotating group in a first closed-loop circuit;
a flow control module fluidly coupled to the first closed-loop circuit via a first conduit;
a second actuator fluidly coupled to the flow control module via a second conduit;
a second rotating group in selective fluid communication with the first conduit and the second conduit via the flow control module; and
a controller operatively coupled to the flow control module, the controller being configured to
operate the flow control module in a first mode, such that the flow control module effects fluid communication between the second rotating group and the first closed-loop circuit via the first conduit, and blocks fluid communication between the second rotating group and the second actuator via the second conduit, and
operate the flow control module in a second mode, such that the flow control module blocks fluid communication between the second rotating group and the first closed-loop circuit via the first conduit, and effects fluid communication between the second rotating group and the second actuator via the second conduit.

11. The machine of claim 10, wherein the machine is an excavator.

12. The machine of claim 11, wherein the first actuator is one of a boom hydraulic cylinder and a stick hydraulic cylinder.

13. The machine of claim 11, wherein the second actuator is a rotary travel motor.

14. A method of controlling a hydraulic system, the hydraulic system including
a first actuator fluidly coupled to a first rotating group in a first closed-loop circuit,
a flow control module fluidly coupled to the first closed-loop circuit via a first conduit,
a second actuator fluidly coupled to the flow control module via a second conduit, and
a second rotating group in selective fluid communication with the first conduit and the second conduit via the flow control module, the method comprising:
operating the flow control module in a first mode, including
effecting fluid communication between the second rotating group and the first closed-loop circuit via the first conduit, and
blocking fluid communication between the second rotating group and the second actuator via the second conduit, and
operating the flow control module in a second mode, including
blocking fluid communication between the second rotating group and the first closed-loop circuit via the first conduit, and
effecting fluid communication between the second rotating group and the second actuator via the second conduit.

15. The method of claim 14, further comprising actuating the first actuator via the first rotating group while simultaneously actuating the second actuator via the second rotating group.

16. The method of claim 14, wherein the hydraulic system further includes
a third actuator fluidly coupled to a third rotating group in a second closed-loop circuit, the second closed-loop circuit being coupled to the flow control module via a third conduit;
a fourth actuator fluidly coupled to the flow control module via a fourth conduit;
a fourth rotating group in selective fluid communication with the third conduit and the fourth conduit via the flow control module,
wherein operating the flow control module in e first mode further includes
effecting fluid communication between the fourth rotating group and the second closed-loop circuit via the third conduit, and
blocking fluid communication between the fourth rotating group and the fourth actuator via the fourth conduit, and
wherein operating the flow control module in the second mode further includes
blocking fluid communication between the fourth rotating group and the second closed-loop circuit via the third conduit, and
effecting fluid communication between the fourth rotating group and the fourth actuator via the fourth conduit.

17. The method according to claim 14, further comprising converting shaft power from a prime mover into hydraulic power through the first conduit via the second rotating group.

18. The method according to claim 14, further comprising converting hydraulic power from the first conduit into shaft power output from the second rotating group.

19. The method according to claim 14, further comprising storing hydraulic energy from the first conduit in an accumulator.

20. The method according to claim 16, further comprising actuating the third actuator via the third rotating group while simultaneously actuating the fourth actuator via the fourth rotating group.
